(19) United States
(12) Patent Application Publication
(10) Pub. No.: US 2019/0180206 A1
(43) Pub. Date: Jun. 13, 2019

(54) Conversation-driven workflow

(71) Applicant: International Business Machines Corporation, Armonk, NY (US)

(72) Inventors: Scott Prager, Stratham, NH (US); Michael G. Winter, Camarillo, CA (US)

(21) Appl. No.: 15/841,270

(22) Filed: Dec. 13, 2017

(51) Int. Cl. G06Q 10/06; G06F 17/28

(52) U.S. Cl. CPC G06Q 10/0633; G06F 17/28

(57) ABSTRACT

Methods and apparatus, including computer program products, implementing and using techniques for managing a workflow. A natural language classification engine collets a first set of natural language data that indicates a workflow process. Based on the first set of natural language data, a workflow process action is identified. A second set of natural language data that indicates a workflow process action response is collected. Based on the workflow process action response, a workflow progression operation is determined. The workflow progression operation is executed to progress the workflow process.

### BACKGROUND

The present invention relates to workflow processes, and more specifically, to how to initiate, track and progress workflow processes and exceptions in a workflow processing system.

Workflow provides structure to business processes through the creation of flowcharts and rules representing the steps of the process and decision points. Individuals are then able to create and progress workflow processes by advancing, approving, rejecting, initiating exceptions, etc. While workflows enforce rules and provide structure and consistency, which are crucial to repeatable business processes, they also require users to leverage workflow tools and actions to perform user-initiated state transitions and when initiating exceptions, to manually control, modify or diverge from the workflow. This is often cumbersome, often requires additional actions to advance the flow in addition to any workflow related collaboration or conversation, and requires training of users in the particular workflow product and interface.

### SUMMARY

According to one embodiment of the present invention, methods, systems and computer program products are provided for managing a workflow. A natural language classification engine collets a first set of natural language data that indicates a workflow process. Based on the first set of natural language data, a workflow process action is identified. A second set of natural language data that indicates a workflow process action response is collected. Based on the workflow process action response, a workflow progression operation is determined. The workflow progression operation is executed to progress the workflow process.

The details of one or more embodiments of the invention are set forth in the accompanying drawings and the description below. Other features and advantages of the invention will be apparent from the description and drawings, and from the claims.

### BRIEF DESCRIPTION OF THE DRAWINGS

FIG. 1 shows an example of a basic workflow 100 in accordance with one embodiment.

FIG. 2 shows a schematic block diagram of a system 200 in accordance with one embodiment.

FIG. 3 shows an exemplary configuration of a computer 1900 in accordance with one embodiment.

Like reference symbols in the various drawings indicate like elements.

### DETAILED DESCRIPTION

The various embodiments of the invention pertain to techniques for initiating, tracking and progressing workflow processes and exceptions, by using natural language and human conversation to eliminate the need for most users to interact with the underlying workflow process and workflow tooling. The actual workflow process is still created and advanced to ensure that business rules and tracking are enforced, but this is done implicitly based on natural language that represents common workflow actions (and that can also be extended with specific domain or other language to expand beyond just universal workflow-related terminology).

As a high-level example, in a discussion channel where a conference of interest is being discussed, a user saying “I'd like to go to this conference” could initiate a travel approval workflow, bringing in that user's appropriate approvers—but by bringing them into the conversation (whether the core conversation or a side branch) where they can then converse in natural language with the requester while that language is used to advance through travel approval steps. On approval (also natural language, such as the approver indicating “yes, I think you should go”), the workflow engine can then post in the conversational interface any necessary workflow approval information, and the users have had no interaction with the workflow system.

In some embodiments, this system can be extended to handle workflow exceptions as well by either capturing language specific to exceptions (e.g.—“I'll need additional data to handle this”) or by having workflow limits trigger actions in the conversation space (e.g. —exceeding a cost limit automatically brings in a higher-level approver to the conversation stream with the workflow agent/bot posting an explanation in the conversation such as “John has been added because the cost exceeds the $100K threshold, requiring VP approval”).

When needed, the workflow can be halted until the conversation indicates that the exception has been handled. Since the workflow is still being tracked under the covers/hidden from the users, all rules are still enforced and results are tracked in normal business systems. As appropriate, the workflow agent could optionally interject explanations or guidance, but this is done while still avoiding user interaction with the workflow system itself, within the conversation flow.

Workflows consist of states, state transitions, rules and user actions. All of these have corresponding natural language, which can be implemented in a classifier to capture text (or speech) that maps to a common set of actions and questions. This begins with a set of basic workflow actions and the language commonly used to indicate (1) a request/task initiation, approval, rejection, completion, (2) common questions that map to data or content related to the workflow, and (3) phrasing which represents initiation and handling of exceptions.

This allows the system to identify workflow transitions and actions which can then be mapped to state transitions. The initiation of a specific workflow can either be done through language indicating that workflow or by having a particular conversation channel mapped to a particular process. An example of the latter would be a support channel where new entries/requests create a problem ticket or support flow that can subsequently be progressed. An example of the former would add appropriate phrasing to workflows to help the system identify the appropriate flow to initiate (e.g.—for travel approval, phrasing referring to “attend a conference”, “visit a customer”, etc.) which could then be implemented in multiple channels. This is then implemented through standard natural language classifiers to identify appropriate processes.

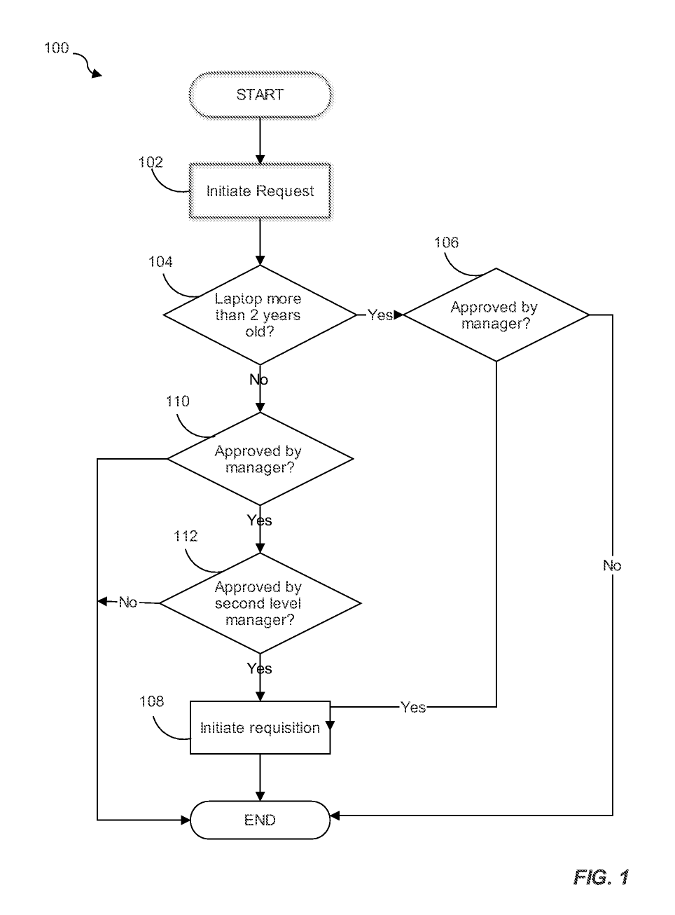

Various embodiments will now be described by way of example and with reference to the figures. FIG. 1 shows an example of a basic workflow 100 for requesting a new laptop. As can be seen in FIG. 1, the workflow 100 starts by an employee initiating a request, step 102. It is then determined if the laptop is more than two years old, step 104. If the laptop is more than two years old, a request is sent to the employee's manager for approval, step 106. If the manager approves the request, requisition of a new laptop is initiated, step 108, and the requisition process ends. If the manager does not approve the requisition in step 106, the process ends.

If it is determined in step 104 that the laptop is less than two years old, approval is also needed from a second level manager. Therefore, a request is first sent to the employee's manager for approval, step 110. If the manager does not approve the request, the process 100 ends. If the manager approves the request in step 110, the request is forwarded to the second level manager, step 112. If the second level manager also approves the request, the request is initiated, step 108, and the process 100 ends. However, if the second level manager does not approve the request, the process 100 ends.

The conversation stream corresponding to the workflow process of FIG. 1 might look as follows in a channel in which the employee (Joe) and his manager (Sue) are in:
Joe: “Sue, I need to get a new laptop, mine is too slow.”
Sue: “OK—I approve that.”
<workflow system>: “Joe's laptop is less than 2 years old. Adding second line manager Fred for review.”
Fred: “Joe, why do you need a new laptop when yours is not that old?”
Joe: “New project requires a more powerful system than I have.”
Fred: “OK—I agree.”

In this example, the workflow process was initiated and followed but from the users' perspective, they simply had a conversation. By the system understanding phrases like “get a new laptop,” “I approve,” and “I agree,” there was no need to interact with the workflow process or tooling, but its rules and process were fully implemented. In addition, since this occurs in a conversation stream, it is much faster and efficient compared to using a separate tool and also (when appropriate) more broadly visible.

To continue the above example, the workflow system may then continue the dialog with Joe and potentially other users to fulfill the request for the laptop, for example, as follows:
<workflow system>: “Joe, your laptop request has been approved. We've engaged Tom from procurement to assist with that. Tom will reach out to you for details.”
Tom: “Joe, based on our systems it looks like you qualify for one of the following systems: A, B, C. Let me know which one you prefer.”
Joe: “Tom, I'd like to have system A. Thanks.”

It should be noted that while the process 100 has been described as a “single pass” process, typically this process would be running continuously during ongoing conversations and would continuously keep identifying workflow related topics and implement them. For example, there could be five approvals, 10 rules/triggers, two exceptions, etc. in a single conversation and several workflow processes could be initiated by the conversation.

Regarding exception handling, a simple example extending from the example above can be as follows, where exception language triggers such as “before proceeding” and “first check” trigger an exception which halts the workflow until the exception is resolved, and at which point it continues. An additional benefit of this handling is that the handling of the exception is documented in the conversation even though it is outside the normal processing of the workflow process (and would not have been maintained in that process without explicitly entering it in the workflow system, something that's unlikely to happen). For example, in the above example, assume Fred did not say “Ok—I agree,” But instead that the dialog would continue as follows:
Fred: “Before proceeding we've been asked by leadership to first check whether reclaimed/recycled hardware can fulfill new requests. Joe—please check that out. If not then I approve”
<workflow system>: “Placing ordering process on hold for exception: check whether reclaimed/recycled hardware can fulfill new requests”
Joe: “I've checked and there isn't anything that meets my needs.”
<workflow system>: “Exception closed. Proceeding with order”

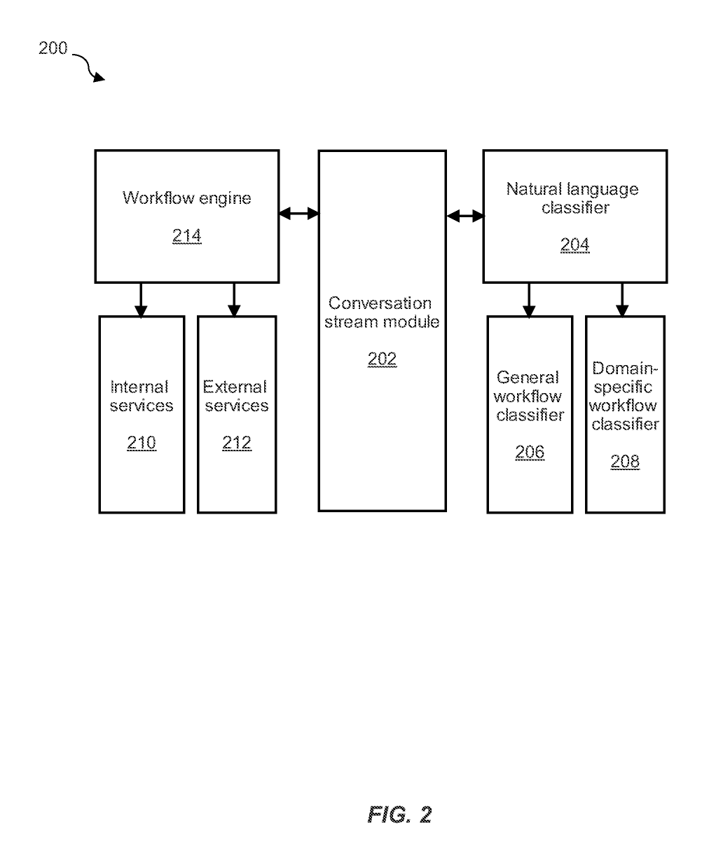

Architecturally, the above process can be implemented in a variety of systems that include some kind of collaboration tools. A schematic example of a system 200 in which the above techniques can be implemented is shown in FIG. 2. As can be seen in FIG. 2, the system 200 includes a conversation stream module 202, a natural language classifier 204, a general workflow classifier 206, a domain-specific workflow classifier 208, a workflow engine 214, an internal services module 210 and an external services module 212. It should be noted that while the components of the system 200 are shown as individual units, they may be combined in various ways and implement the same functionality that was described above with respect to the process 100 of FIG. 1.

The conversation stream module 202 is where the participants discuss in natural language and are being added as needed to route/approve requests, provide expertise, etc., as described above. The conversation stream module 202 effectively works as the “user interface” to the workflow process and may implement functionality similar to what is available in products such as Watson Workspaces or Slack. Watson Workspaces is available from International Business Machines Corporation (IBM) of Armonk, N.Y., and Slack is available from Slack Technologies Inc., of Vancouver, BC, Canada. In some embodiments, the workflow system is also enhanced to participate in the conversation when needed by mapping appropriate rules and actions in the workflow into actions in the conversation stream—such as adding an approver and notifying them, or noting decision criteria.

The natural language classifier 204 identifies intents and actions from human natural language in the conversation stream module 202, as described above. The natural language classifier 204 is configured to capture and classify common workflow-related actions. Such classifiers can be built and implemented, for example, through a system such as Watson Natural Language Classifier, also available from IBM. This allows the system to map the workflow-related actions to workflow state transitions. In FIG. 2, there are two general types of classifiers; a general workflow classifier 206 and a domain-specific workflow classifier 208. The general workflow classifier 206 captures terminology relating to general workflows, such as “flow,” “approval,” etc. The domain-specific workflow classifier 208 captures terminology relating to domain-specific workflow language, such as (in the case of auto insurance, for example) “getting repair estimates,” “extending car rental,” “retrieving police reports,” etc. As the skilled person realizes, in some cases, such requests are easy to map to content, but in various domain-specific processes, additional classifiers are needed to map common requests, and such classifiers can be implemented as needed.

The system 200 can communicate with various internal services 210 and external services 212 through a workflow engine 214 to obtain data that is needed to implement the workflow. For example, the internal services 210 can include claims forms, policies, etc., and the external services 212 can include medical information, police reports, email communications, etc. As the skilled person realizes, there is virtually an unlimited amount of internal and external services that can be connected to the workflow management system 200. The workflow engine 214 accesses the internal services 210 and the external services 212 as needed to obtain the necessary data and to progress the workflow as needed.

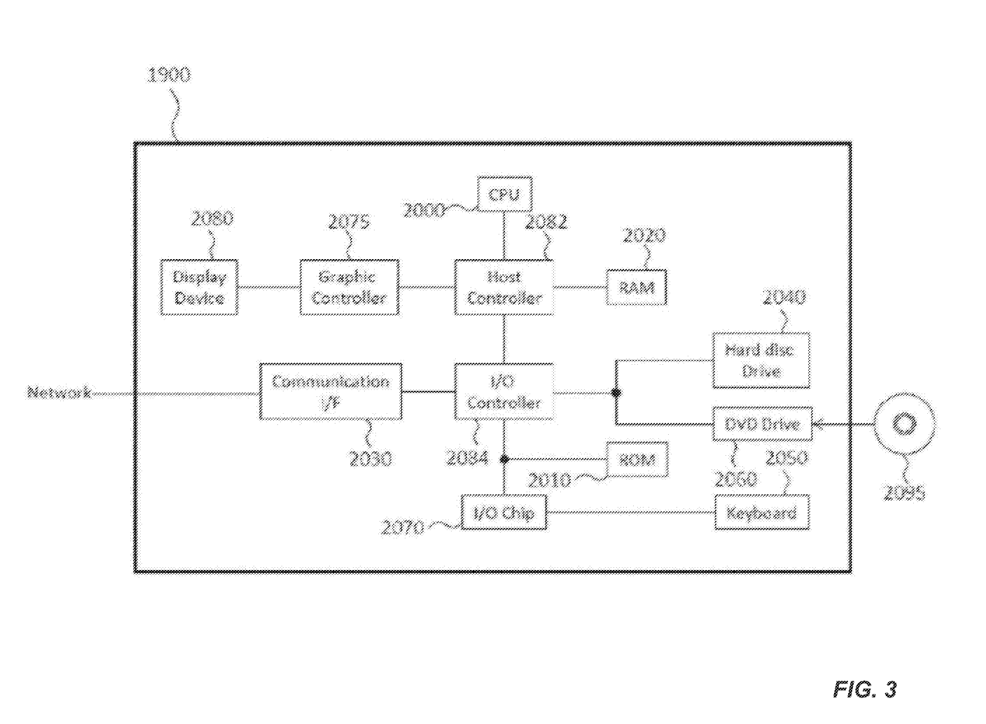

FIG. 3 shows an exemplary configuration of a computer 1900 in accordance with one embodiment. The computer 1900 according to the present embodiment includes a CPU 2000, a RAM 2020, a graphics controller 2075, and a display apparatus 2080 which are mutually connected by a host controller 2082. The computer 1900 also includes input/output units such as a communication interface 2030, a hard disk drive 2040, and a DVD-ROM drive 2060 which are connected to the host controller 2082 via an input/output controller 2084. The computer also includes legacy input/output units such as a ROM 2010 and a keyboard 2050 which are connected to the input/output controller 2084 through an input/output chip 2070.

The host controller 2082 connects the RAM 2020 with the CPU 2000 and the graphics controller 2075 which access the RAM 2020 at a high transfer rate. The CPU 2000 operates according to programs stored in the ROM 2010 and the RAM 2020, thereby controlling each unit. The graphics controller 2075 obtains image data generated by the CPU 2000 on a frame buffer or the like provided in the RAM 2020, and causes the image data to be displayed on the display apparatus 2080. Alternatively, the graphics controller 2075 may contain therein a frame buffer or the like for storing image data generated by the CPU 2000.

The input/output controller 2084 connects the host controller 2082 with the communication interface 2030, the hard disk drive 2040, and the DVD-ROM drive 2060, which are relatively high-speed input/output units. The communication interface 2030 communicates with other electronic devices via a network. The hard disk drive 2040 stores programs and data used by the CPU 2000 within the computer 1900. The DVD-ROM drive 2060 reads the programs or the data from the DVD-ROM 2095, and provides the hard disk drive 2040 with the programs or the data via the RAM 2020.

The ROM 2010 and the keyboard 2050 and the input/output chip 2070, which are relatively low-speed input/output units, are connected to the input/output controller 2084. The ROM 2010 stores therein a boot program or the like executed by the computer 1900 at the time of activation, a program depending on the hardware of the computer 1900. The keyboard 2050 inputs text data or commands from a user, and may provide the hard disk drive 2040 with the text data or the commands via the RAM 2020. The input/output chip 2070 connects a keyboard 2050 to an input/output controller 2084, and may connect various input/output units via a parallel port, a serial port, a keyboard port, a mouse port, and the like to the input/output controller 2084.

A program to be stored on the hard disk drive 2040 via the RAM 2020 is provided by a recording medium as the DVD-ROM 2095, and an IC card. The program is read from the recording medium, installed into the hard disk drive 2040 within the computer 1900 via the RAM 2020, and executed in the CPU 2000.

A program that is installed in the computer 1900 and causes the computer 1900 to function as an apparatus implementing the process 100 of FIG. 1, includes a natural language processing module. The program or module acts on the CPU 2000, to cause the computer 1900 to function as one or more sections, components, or elements of the system 100 of FIG. 2.

The information processing described in these programs is read into the computer 1900, to function as the determining section, which is the result of cooperation between the program or module and the above-mentioned various types of hardware resources. Moreover, the apparatus is constituted by realizing the operation or processing of information in accordance with the usage of the computer 1900.

For example, when communication is performed between the computer 1900 and an external device, the CPU 2000 may execute a communication program loaded onto the RAM 2020, to instruct communication processing to a communication interface 2030, based on the processing described in the communication program. The communication interface 2030, under control of the CPU 2000, reads the transmission data stored on the transmission buffering region provided in the recording medium, such as a RAM 2020, a hard disk drive 2040, or a DVD-ROM 2095, and transmits the read transmission data to a network, or writes reception data received from a network to a reception buffering region or the like provided on the recording medium. In this way, the communication interface 2030 may exchange transmission/reception data with the recording medium by a DMA (direct memory access) method, or by a configuration that the CPU 2000 reads the data from the recording medium or the communication interface 2030 of a transfer destination, to write the data into the communication interface 2030 or the recording medium of the transfer destination, so as to transfer the transmission/reception data.

In addition, the CPU 2000 may cause all or a necessary portion of the file of the database to be read into the RAM 2020, such as by DMA transfer, the file or the database having been stored in an external recording medium such as the hard disk drive 2040, the DVD-ROM drive 2060 (DVD-ROM 2095) to perform various types of processing onto the data on the RAM 2020. The CPU 2000 may then write back the processed data to the external recording medium by means of a DMA transfer method or the like. In such processing, the RAM 2020 can be considered to temporarily store the contents of the external recording medium, and so the RAM 2020, the external recording apparatus, and the like are collectively referred to as a memory, a storage section, a recording medium, a computer readable medium, etc. Various types of information, such as various types of programs, data, tables, and databases, may be stored in the recording apparatus, to undergo information processing. Note that the CPU 2000 may also use a part of the RAM 2020 to perform reading/writing thereto on the cache memory. In such an embodiment, the cache is considered to be contained in the RAM 2020, the memory, and/or the recording medium unless noted otherwise, since the cache memory performs part of the function of the RAM 2020.

The CPU 2000 may perform various types of processing, onto the data read from the RAM 2020, which includes various types of operations, processing of information, condition judging, search/replace of information, etc., as described in the present embodiment and designated by an instruction sequence of programs, and writes the result back to the RAM 2020. For example, when performing condition judging, the CPU 2000 may judge whether each type of variable shown in the present embodiment is larger, smaller, no smaller than, no greater than, or equal to the other variable or constant, and when the condition judging results in the affirmative (or in the negative), the process branches to a different instruction sequence, or calls a sub routine.

In addition, the CPU 2000 may search for information in a file, a database, etc., in the recording medium. For example, when a plurality of entries, each having an attribute value of a first attribute is associated with an attribute value of a second attribute, are stored in a recording apparatus, the CPU 2000 may search for an entry matching the condition whose attribute value of the first attribute is designated, from among the plurality of entries stored in the recording medium, and reads the attribute value of the second attribute stored in the entry, thereby obtaining the attribute value of the second attribute associated with the first attribute satisfying the predetermined condition.

The above-explained program or module may be stored in an external recording medium. Exemplary recording mediums include a DVD-ROM 2095, as well as an optical recording medium such as a Blu-ray Disk or a CD, a magneto-optic recording medium such as a MO, a tape medium, and a semiconductor memory such as an IC card. In addition, a recording medium such as a hard disk or a RAM provided in a server system connected to a dedicated communication network or the Internet can be used as a recording medium, thereby providing the program to the computer 1900 via the network.

The present invention may be a system, a method, and/or a computer program product at any possible technical detail level of integration. The computer program product may include a computer readable storage medium (or media) having computer readable program instructions thereon for causing a processor to carry out aspects of the present invention.

The computer readable storage medium can be a tangible device that can retain and store instructions for use by an instruction execution device. The computer readable storage medium may be, for example, but is not limited to, an electronic storage device, a magnetic storage device, an optical storage device, an electromagnetic storage device, a semiconductor storage device, or any suitable combination of the foregoing. A non-exhaustive list of more specific examples of the computer readable storage medium includes the following: a portable computer diskette, a hard disk, a random access memory (RAM), a read-only memory (ROM), an erasable programmable read-only memory (EPROM or Flash memory), a static random access memory (SRAM), a portable compact disc read-only memory (CD-ROM), a digital versatile disk (DVD), a memory stick, a floppy disk, a mechanically encoded device such as punch-cards or raised structures in a groove having instructions recorded thereon, and any suitable combination of the foregoing. A computer readable storage medium, as used herein, is not to be construed as being transitory signals per se, such as radio waves or other freely propagating electromagnetic waves, electromagnetic waves propagating through a waveguide or other transmission media (e.g., light pulses passing through a fiber-optic cable), or electrical signals transmitted through a wire.

Computer readable program instructions described herein can be downloaded to respective computing/processing devices from a computer readable storage medium or to an external computer or external storage device via a network, for example, the Internet, a local area network, a wide area network and/or a wireless network. The network may comprise copper transmission cables, optical transmission fibers, wireless transmission, routers, firewalls, switches, gateway computers and/or edge servers. A network adapter card or network interface in each computing/processing device receives computer readable program instructions from the network and forwards the computer readable program instructions for storage in a computer readable storage medium within the respective computing/processing device.

Computer readable program instructions for carrying out operations of the present invention may be assembler instructions, instruction-set-architecture (ISA) instructions, machine instructions, machine dependent instructions, microcode, firmware instructions, state-setting data, configuration data for integrated circuitry, or either source code or object code written in any combination of one or more programming languages, including an object oriented programming language such as Smalltalk, C++, or the like, and procedural programming languages, such as the “C” programming language or similar programming languages. The computer readable program instructions may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider). In some embodiments, electronic circuitry including, for example, programmable logic circuitry, field-programmable gate arrays (FPGA), or programmable logic arrays (PLA) may execute the computer readable program instructions by utilizing state information of the computer readable program instructions to personalize the electronic circuitry, in order to perform aspects of the present invention.

Aspects of the present invention are described herein with reference to flowchart illustrations and/or block diagrams of methods, apparatus (systems), and computer program products according to embodiments of the invention. It will be understood that each block of the flowchart illustrations and/or block diagrams, and combinations of blocks in the flowchart illustrations and/or block diagrams, can be implemented by computer readable program instructions.

These computer readable program instructions may be provided to a processor of a general purpose computer, special purpose computer, or other programmable data processing apparatus to produce a machine, such that the instructions, which execute via the processor of the computer or other programmable data processing apparatus, create means for implementing the functions/acts specified in the flowchart and/or block diagram block or blocks. These computer readable program instructions may also be stored in a computer readable storage medium that can direct a computer, a programmable data processing apparatus, and/or other devices to function in a particular manner, such that the computer readable storage medium having instructions stored therein comprises an article of manufacture including instructions which implement aspects of the function/act specified in the flowchart and/or block diagram block or blocks.

The computer readable program instructions may also be loaded onto a computer, other programmable data processing apparatus, or other device to cause a series of operational steps to be performed on the computer, other programmable apparatus or other device to produce a computer implemented process, such that the instructions which execute on the computer, other programmable apparatus, or other device implement the functions/acts specified in the flowchart and/or block diagram block or blocks.

The flowchart and block diagrams in the Figures illustrate the architecture, functionality, and operation of possible implementations of systems, methods, and computer program products according to various embodiments of the present invention. In this regard, each block in the flowchart or block diagrams may represent a module, segment, or portion of instructions, which comprises one or more executable instructions for implementing the specified logical function(s). In some alternative implementations, the functions noted in the blocks may occur out of the order noted in the Figures. For example, two blocks shown in succession may, in fact, be executed substantially concurrently, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts or carry out combinations of special purpose hardware and computer instructions.

The descriptions of the various embodiments of the present invention have been presented for purposes of illustration, but are not intended to be exhaustive or limited to the embodiments disclosed. Many modifications and variations will be apparent to those of ordinary skill in the art without departing from the scope and spirit of the described embodiments. The terminology used herein was chosen to best explain the principles of the embodiments, the practical application or technical improvement over technologies found in the marketplace, or to enable others of ordinary skill in the art to understand the embodiments disclosed herein.

What is claimed is:

1. A computer implemented method for managing a workflow, comprising:
collecting, by a natural language classification engine, a first set of natural language data that indicates a workflow process;
identifying, by the natural language classification engine and based on the first set of natural language data, a workflow process action;
collecting, by the natural language classification engine, a second set of natural language data that indicates a workflow process action response;
determining, by the natural language classification engine based on the workflow process action response, a workflow progression operation; and
executing, by the natural language classification engine, the workflow progression operation to progress the workflow process.

2. The method of claim 1, further comprising:
detecting, based on the first set of natural language data, a first natural language element;
determining, based on analyzing the first natural language element with respect to a set of natural-language exception classifiers, that the first language element indicates a first exception with respect to the workflow process action; and
initiating, to execute the workflow progression operation, a first exception handling process with respect to the workflow process.

3. The method of claim 1, further comprising:
detecting, based on the first set of natural language data, a first workflow value with respect to the workflow process;
determining, by computing that the first workflow value exceeds a workflow value threshold, that the first workflow value indicates a first exception with respect to the workflow process action; and
initiating, to execute the workflow progression operation, a first exception-handling process with respect to the workflow process.

4. The method of claim 1, further comprising:
detecting, by the natural language classification engine, that the first set of natural language data includes a dialogue between a plurality of users;
ascertaining, based on the workflow process action with respect to the workflow process, that a first authorization parameter of the plurality of users does not achieve a first authorization threshold with respect to the workflow process action; and
introducing, to execute the workflow progression action, an additional user with respect to the dialogue between the plurality of users, wherein a second authorization parameter of the additional user achieves the first authorization threshold with respect to the workflow process action.

5. The method of claim 1, further comprising:
providing, in response to detecting a workflow data request indicated by the first or second sets of natural language data, a set of workflow context data with respect to the workflow process.

6. The method of claim 5, wherein providing workflow context data includes one or more of retrieving workflow context data from an external system, creating workflow context data in an external system, and modifying workflow context data in an external system.

7. The method of claim 1, wherein the first set of natural language data includes one or more of: a conversation and a data entry submission.

8. A computer program product for managing a workflow, the computer program product comprising a computer readable storage medium having program instructions embodied therewith, wherein the computer readable storage medium is not a transitory signal per se, the program instructions being executable by a processor to cause the processor to perform a method comprising:
collecting a first set of natural language data that indicates a workflow process;
identifying based on the first set of natural language data, a workflow process action;
collecting a second set of natural language data that indicates a workflow process action response;
determining based on the workflow process action response, a workflow progression operation; and
executing the workflow progression operation to progress the workflow process.

9. The computer program product of claim 8, wherein the method further comprises:
detecting, based on the first set of natural language data, a first natural language element;
determining, based on analyzing the first natural language element with respect to a set of natural-language exception classifiers, that the first language element indicates a first exception with respect to the workflow process action; and
initiating, to execute the workflow progression operation, a first exception handling process with respect to the workflow process.

10. The computer program product of claim 8, wherein the method further comprises:
detecting, based on the first set of natural language data, a first workflow value with respect to the workflow process;
determining, by computing that the first workflow value exceeds a workflow value threshold, that the first workflow value indicates a first exception with respect to the workflow process action; and
initiating, to execute the workflow progression operation, a first exception-handling process with respect to the workflow process.

11. The computer program product of claim 8, wherein the method further comprises:
detecting, by the natural language classification engine, that the first set of natural language data includes a dialogue between a plurality of users;
ascertaining, based on the workflow process action with respect to the workflow process, that a first authorization parameter of the plurality of users does not achieve a first authorization threshold with respect to the workflow process action; and
introducing, to execute the workflow progression action, an additional user with respect to the dialogue between the plurality of users, wherein a second authorization parameter of the additional user achieves the first authorization threshold with respect to the workflow process action.

12. The computer program product of claim 8, wherein the method further comprises:
providing, in response to detecting a workflow data request indicated by the first or second sets of natural language data, a set of workflow context data with respect to the workflow process.

13. The computer program product of claim 12, wherein providing workflow context data includes one or more of retrieving workflow context data from an external system, creating workflow context data in an external system, and modifying workflow context data in an external system.

14. The computer program product of claim 8, wherein the first set of natural language data includes one or more of: a conversation and a data entry submission.

15. A workflow management system comprising:
a processor; and
a memory containing instructions that when executed by the processor causes the following method to be performed by the processor:
collecting, by a natural language classification engine, a first set of natural language data that indicates a workflow process;
identifying, by the natural language classification engine and based on the first set of natural language data, a workflow process action;
collecting, by the natural language classification engine, a second set of natural language data that indicates a workflow process action response;
determining, by the natural language classification engine based on the workflow process action response, a workflow progression operation; and
executing, by the natural language classification engine, the workflow progression operation to progress the workflow process.

16. The system of claim 15, further comprising:
detecting, based on the first set of natural language data, a first natural language element;
determining, based on analyzing the first natural language element with respect to a set of natural-language exception classifiers, that the first language element indicates a first exception with respect to the workflow process action; and
initiating, to execute the workflow progression operation, a first exception handling process with respect to the workflow process.

17. The system of claim 15, further comprising:
detecting, based on the first set of natural language data, a first workflow value with respect to the workflow process;
determining, by computing that the first workflow value exceeds a workflow value threshold, that the first workflow value indicates a first exception with respect to the workflow process action; and
initiating, to execute the workflow progression operation, a first exception-handling process with respect to the workflow process.

18. The system of claim 15, further comprising:
detecting, by the natural language classification engine, that the first set of natural language data includes a dialogue between a plurality of users;
ascertaining, based on the workflow process action with respect to the workflow process, that a first authorization parameter of the plurality of users does not achieve a first authorization threshold with respect to the workflow process action; and
introducing, to execute the workflow progression action, an additional user with respect to the dialogue between the plurality of users, wherein a second authorization parameter of the additional user achieves the first authorization threshold with respect to the workflow process action.

19. The system of claim 15, further comprising:
providing, in response to detecting a workflow data request indicated by the first or second sets of natural language data, a set of workflow context data with respect to the workflow process.

20. The system of claim 19, wherein providing workflow context data includes one or more of retrieving workflow context data from an external system, creating workflow context data in an external system, and modifying workflow context data in an external system.
